(19) United States
(12) Patent Application Publication
(10) Pub. No.: US 2026/0227594 A1
(43) Pub. Date: Aug. 6, 2026

(54) LENS MODULE, OPTICAL APPARATUS, IMAGING APPARATUS, ELECTRONIC EQUIPMENT, AND MANUFACTURING METHOD FOR LENS MODULE

(71) Applicant: CANON KABUSHIKI KAISHA, Tokyo (JP)

(72) Inventors: KAZUHIRO KOCHI, Kanagawa (JP); SHUSUKE TOBITA, Kanagawa (JP)

(21) Appl. No.: 19/458,459

(22) Filed: Jan. 23, 2026

(30) Foreign Application Priority Data
Jan. 27, 2025 (JP) 2025-011274
Nov. 4, 2025 (JP) 2025-185791

(51) Int. Cl. G02B 7/02; B29D 11/00; G02B 27/00

(52) U.S. Cl. CPC G02B 7/021; B29D 11/00019; G02B 7/025; G02B 7/028; G02B 27/0018

(57) ABSTRACT

A lens module including a first unit including a first lens and a first holder made of a material different from a material of the first lens and configured to hold the first lens and a second unit including a second lens and a second holder made of a material different from a material of the second lens and configured to hold the second lens. The first lens and the second lens overlap in an optical axis direction of the lens module, and the first holder and the second holder fit with each other.

### BACKGROUND

### Field of the Technology

The present disclosure relates to a lens module, an optical apparatus, an imaging apparatus, electronic equipment, and a manufacturing method for the lens module.

### Description of the Related Art

In recent years, along with the improvement of the accuracy of a CMOS sensor and the development of the communication technology, cameras have been mounted on various types of equipment and there has been increasing demand for a small lens module (lens unit) composed of a plurality of lenses for use in such cameras. In the small lens module, a small-diameter plastic lens is often used.

International Publication No. WO2010/103942 discloses a lens group in which a first lens composition layer LY1 including a first lens G1 and a non-lens section and a second lens composition layer LY2 including a second lens G1 are coupled via a spacer layer RB.

In the configuration disclosed in International Publication No. WO2010/103942, satisfactory optical characteristics may not be secured due to inappropriate alignment of the lenses.

### SUMMARY

The present disclosure, which has been made in view of such circumstances, is to provide a lens module having satisfactory optical characteristics, an optical apparatus, an imaging apparatus, and electronic equipment using the lens module, and a manufacturing method for the lens module.

A lens module according to an aspect of the present disclosure is a lens module including: a first unit including a first lens and a first holder made of a material different from a material of the first lens and configured to hold the first lens; and a second unit including a second lens and a second holder made of a material different from a material of the second lens and configured to hold the second lens, wherein the first lens and the second lens overlap in an optical axis direction of the lens module, and the first holder and the second holder fit with each other.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view of a lens module according to a first embodiment of the present disclosure.

FIG. 2 is a sectional view of the lens module exemplified in FIG. 1.

FIG. 3 is a flowchart illustrating a manufacturing method for a lens module according to the embodiment of the present disclosure.

FIG. 4 is a perspective view of a unit included in the lens module exemplified in FIG. 1.

FIG. 5 is a sectional schematic diagram for describing taper alignment at the time when a plurality of units in the lens module exemplified in FIG. 1 are joined.

FIG. 6 is a sectional schematic diagram for describing a joined state of two units in the lens module exemplified in FIG. 1.

FIG. 7 is a sectional schematic diagram for describing a joined state of three units in the lens module exemplified in FIG. 1.

FIG. 8 is a sectional schematic diagram for describing a joined state of three holder-integrated lens modules and a light blocking member in the lens module exemplified in FIG. 1.

FIG. 9 is a sectional schematic diagram for describing a joined state of four units in the lens module exemplified in FIG. 1.

FIG. 10 is a perspective view for describing an example of a joining method for units.

FIG. 11 is a plan view illustrating arrangement of positioning protrusions in a lens module according to a second embodiment of the present disclosure.

FIG. 12 is a sectional schematic diagram illustrating a part of an assembly method by the positioning protrusions in the second embodiment.

FIG. 13 is a sectional schematic diagram illustrating another aspect in the second embodiment.

FIG. 14 is a sectional schematic diagram illustrating another aspect in the second embodiment.

FIG. 15 is a perspective view of a lens module according to a third embodiment of the present disclosure.

FIG. 16A is a sectional schematic diagram for describing an assembly method for the lens module exemplified in FIG. 15.

FIG. 16B is a sectional schematic diagram for describing the assembly method for the lens module and is a diagram illustrating the next process of FIG. 16A.

FIG. 16C is a sectional schematic diagram for describing the assembly method for the lens module and is a diagram illustrating the next process of FIG. 16B.

FIG. 17A is a sectional schematic diagram for describing an assembly method for a lens module according to a fourth embodiment of the present disclosure.

FIG. 17B is a sectional schematic diagram for describing the assembly method for the lens module and is a diagram illustrating the next process of FIG. 17A.

FIG. 17C is a sectional schematic diagram for describing the assembly method for the lens module and is a diagram illustrating the next process of FIG. 17B.

FIG. 18A is a diagram illustrating an example of an imaging apparatus using a lens module according to the present disclosure.

FIG. 18B is a diagram illustrating an example of an optical system of the imaging apparatus exemplified in FIG. 18A.

FIG. 19 is a diagram illustrating an example of an information terminal using the lens module according to the present disclosure.

### DESCRIPTION OF THE EMBODIMENTS

Modes for carrying out the present disclosure are described below as embodiments with reference to the drawings. However, the embodiments described below are embodiments of disclosure and are not limited thereto. A plurality of features are described in the embodiments. However, not all of the plurality of features are essential for the disclosure and the plurality of features may be optionally combined. Further, dimensions, materials, relative positions of constituent elements, and the like described in the embodiments below are optional and can be changed according to configurations of apparatuses or various conditions to which the present disclosure is applied.

Common components are described with reference to a plurality of drawings one another and explanation is omitted as appropriate concerning components denoted by common signs. Separate matters having the same name can be distinguished by adding ordinal numbers like a first matter and a second matter. Words such as substantially the same and substantially coinciding described below mean states that can be referred to as the same and coinciding when differences that can occur in dimension accuracy, which occur at the time of assembly or at the time of manufacturing of individual components, such as manufacturing errors are considered.

### First Embodiment

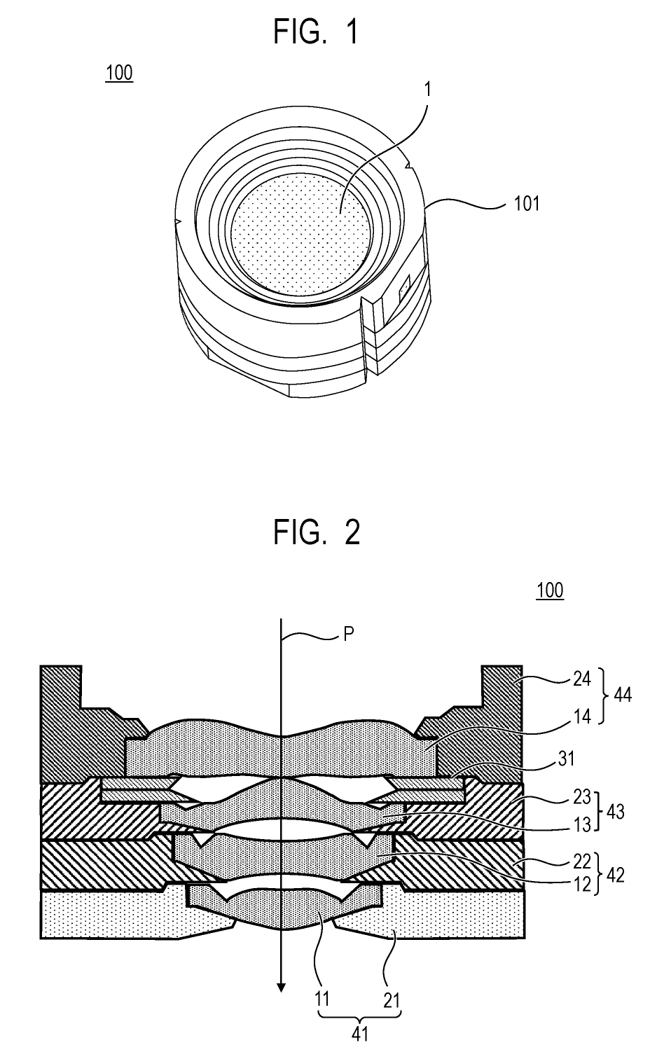

A lens unit (a lens module 100) according to a first embodiment of the present disclosure is described with reference to FIG. 1 and FIG. 2. FIG. 1 is a perspective view of the lens module 100. The lens module 100 according to the present embodiment includes a lens section 1 composed of a transparent member and a lens barrel 101 arranged in the outer circumferential portion of the lens section 1.

FIG. 2 is a sectional view illustrating a schematic configuration in a plane including an optical axis P of the lens module 100. The lens module 100 according to the first embodiment is composed of four units 41, 42, 43, and 44 that are respectively a first unit to a fourth unit. The unit is composed of a partial lens barrel and a lens integrally joined to the partial lens barrel. In the present embodiment, the unit 41 includes a lens 11, which is a first lens, and a partial lens barrel 21, which is a first holder, and the unit 42 includes a lens 12, which is a second lens, and a partial lens barrel 22, which is a second holder. The unit 43 includes a lens 13 and a partial lens barrel 23 and the unit 44 includes a lens 14 and a partial lens barrel 24. A light blocking member 31 described below is arranged between the unit 43 and the unit 44.

The four units 41, 42, 43, and 44 are arranged such that the respective lenses 11, 12, 13, and 14 are arranged side by side from an object side to an imaging element side in this order. Optical axes of the respective lenses 11, 12, 13, and 14 are arranged to substantially coincide with the optical axis P and are integrally joined by, for example, an adhesive in this state. The lens barrel 101 illustrated in FIG. 1 is composed of the partial lens barrels 21, 22, 23, and 24 and the lens section 1 is composed of the lenses 11, 12, 13, and 14 and the light blocking member 31 housed on the inside of the lens barrel 101. In the example illustrated in the figure, the lens 11 is arranged on the object side and the lens 14 is arranged on the imaging element side not illustrated in the figure.

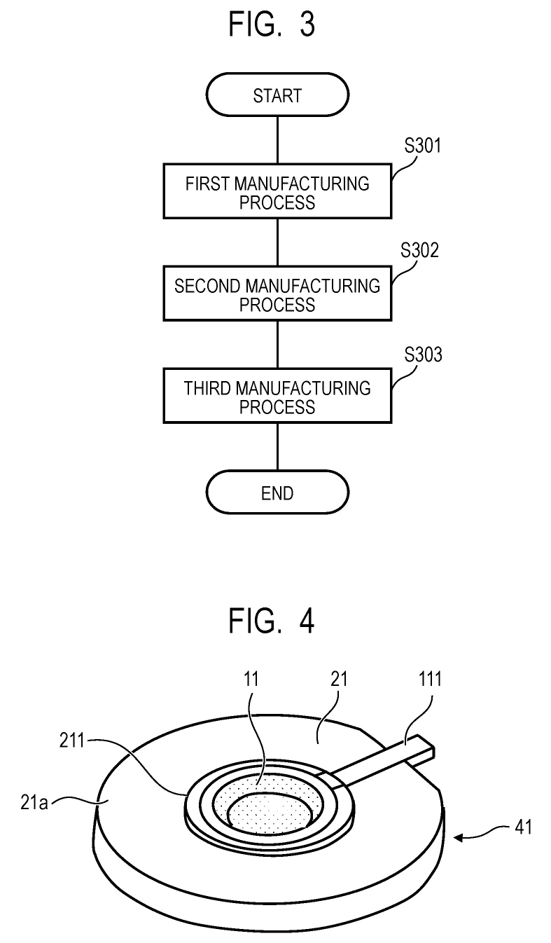

Next, a manufacturing method for a lens module according to the present disclosure is described with reference to FIG. 3 to FIG. 10. The manufacturing method for the lens module according to the present disclosure includes a first manufacturing process to a third manufacturing process (step S301 to step S303) as illustrated in a flowchart of FIG. 3. The respective manufacturing processes in manufacturing the lens module 100 exemplified in FIG. 1 and FIG. 2 are described below.

Concerning the manufacturing of the lens module, first, the first manufacturing process in step S301 is executed. In the first manufacturing process, each of the four units 41, 42, 43, and 44 in the lens module 100 exemplified in FIG. 2 is manufactured. Here, as an example, a manufacturing process for the unit 41 is described.

FIG. 4 is a perspective view of the unit 41. Note that, here, an example in which the unit 41 is manufactured such that the lens 11 and the partial lens barrel 21 are integrally joined by insert molding is described. Note that a manufacturing method for the unit is not limited to the insert molding method exemplified here. Other publicly-known manufacturing methods can be applied to the present disclosure if a lens and a partial lens barrel can be integrally manufactured. A two-color molding method is a method in which a lens and a partial lens barrel can be integrally molded by a composite die obtained by integrating a die for a first color and a die for a second color. The two-color molding method can be regarded as a type of the insert molding method in that a molded body of the first color is arranged in the die for the second color at the time of molding of the second color.

In an actual manufacturing method, a flow path of a gate 111 for lens molding is provided in advance in the partial lens barrel 21 manufactured in advance. The partial lens barrel 21 is installed in a die and a material for forming the lens 11 is fed into the partial lens barrel 21 through the flow path of the gate 111. The unit 41 in which the partial lens barrel 21 and the lens 11 are integrally joined is manufactured through such a process.

Note that, as a first material for manufacturing the lens 11, transparent resin represented by polycarbonate, acrylic resin, or cyclic olefin polymer (cyclo olefin polymer) can be used. A glass material or the like represented by BK7 may be used as the first material. The first material can be selected based on lens performance required of the lens 11. The glass transition temperature (Tg) of polycarbonate is 140 to 150°C and the coefficient of linear expansion of polycarbonate is 3 to 7×10⁻⁵/°C. The glass transition temperature (Tg) of acrylic resin is 100to 120°C and the coefficient of linear expansion of acrylic resin is 5 to 9×10⁻⁵/°C. The glass transition temperature (Tg) of cyclic olefin polymer is 130 to 150°C and the coefficient of linear expansion of cyclic olefin polymer is 6 to 7×10⁻⁵/°C.

The partial lens barrel 21 is desirably made of a second material different from the material of the lens 11, for example, a black resin material in order to prevent stray light. When the lens 11 is made of the resin material, the resin material of the lens 11 can be integrated with the resin material of the partial lens barrel 21 in a compatible state. A "Compatible" state indicates that two materials of the partial lens barrel 21 and the lens 11 are mutually dissolved (i.e. mixed or blended), a clear interface is absent in the boundary between the partial lens barrel 21 and the lens 11, and both the materials are diffused and integrated. In this case, it can be said that the resin material of the lens 11 has compatibility with the resin material of the partial lens barrel 21. An "Incompatible" state indicates that two materials of the partial lens barrel 21 and the lens 11 are not mutually dissolved, a clear boundary is present between the partial lens barrel 21 and the lens 11, and the partial lens barrel 21 and the lens 11 are mechanically joined (the mechanical joint may be formed by an anchor structure). Even when the lens 11 is made of the resin material, the lens 11 and the partial lens barrel 21 may be in contact with each other to form an interface such that the resin material of the lens 11 is integrated with the resin material of the partial lens barrel 21 while being not mutually dissolved (i.e. in incompatible state). In this case, the resin material of the lens 11 has incompatibility with the resin material of the partial lens barrel 21. Incompatible indicates that the material of the partial lens barrel 21 and the material of the lens 11 form an interface at the boundary between the partial lens barrel 21 and the lens 11 to be in contact and integrated.

Examples of a resin material having compatibility with the polycarbonate exemplified as the resin material of the lens 11 include polycarbonate, acrylonitrile butadiene styrene, and polybutylene terephthalate. These resin materials can be used as the resin material of the partial lens barrel 21. Examples of a resin material having incompatibility with the polycarbonate exemplified as the resin material of the lens 11 include polyethylene, polypropylene, polyacetal, nylon, and polyphenylene sulfide. These resin materials can be used as the resin material of the partial lens barrel 21.

Examples of the resin material having compatibility with the acrylic resin exemplified as the resin material of the lens 11 include polystyrene and acrylic resin. These resin materials can be used as the resin material of the partial lens barrel 21. Examples of the resin material having incompatibility with the acrylic resin exemplified as the resin material of the lens 11 include polyethylene, polypropylene, polyacetal, nylon, and polyphenylene sulfide. These resin materials can be used as the resin material of the partial lens barrel 21.

Examples of the resin material having compatibility with the cyclic olefin polymer exemplified as the resin material of the lens 11 include polyethylene and polypropylene. The materials exemplified here and the like can be used as the resin material of the partial lens barrel 21. Examples of the resin material having incompatibility with the cyclic olefin polymer exemplified as the resin material of the lens 11 include polycarbonate, polybutylene terephthalate, polyether ether ketone, and polyphenylene sulfide. The materials exemplified here and the like can be used as the resin material of the partial lens barrel 21.

When a combination having compatibility is selected in the selection of the resin materials of the lens 11 and the partial lens barrel 21, a firm joint surface can be obtained when the lens 11 and the partial lens barrel 21 are insert-molded. For this reason, an effect of preventing the lens 11 from easily dropping from the partial lens barrel 21 when an external force is applied at the time of assembly of units and under the use of the lens module 100 is obtained. On the other hand, when a combination having incompatibility is selected in the selection of the resin materials of the lens 11 and the partial lens barrel 21, the joint surface of the lens 11 and the partial lens barrel 21 is joined by a frictional force and is weaker than the combination having compatibility. In this case, the configuration is advantageous when a temperature change has occurred in the lens module 100. This is because, when a difference in a coefficient of linear expansion is present between the materials of the lens 11 and the partial lens barrel 21, when a temperature change occurs, a force of a material having a large coefficient of linear expansion pulling a material having a small coefficient of linear expansion can be generated to cause deformation on an optically functional surface of the lens 11. However, since the materials are incompatible and do not have a strong joint surface, the pulling force can be absorbed by a frictional force and an elastic force of the joint surface and the pulling force generated on the joint surface is less easily transmitted to the optically functional surface of the lens 11. Accordingly, it is possible to suppress the deformation of the optically functional surface of the lens 11 due to the temperature change in the selection of the resin materials having incompatibility.

When amorphous resin such as acrylonitrile butadiene styrene or polycarbonate is selected as the resin material of the partial lens barrel 21, the glass transition temperature of the resin material of the lens 11 is desirably lower than the glass transition temperature of the resin material of the partial lens barrel 21. With such a material, when the lens 11 to be a molded component having a second color is injection-molded in the insert molding, the influence of surface texture of the partial lens barrel 21 being collapsed by heat decreases when a melted lens resin material passes the surface of the partial lens barrel 21. As a result, an effect of easily maintaining the shape of a function surface such as an embossed surface for light blocking formed on the partial lens barrel 21 is obtained.

When crystalline resin such as polyethylene or polypropylene is selected as the resin material of the partial lens barrel 21, the glass transition temperature of the resin material of the lens 11 is desirably lower than the melting point of the resin material of the partial lens barrel 21. This is because, as at the time when the amorphous resin is selected for the partial lens barrel 21, when the lens 11 to be the molded component having the second color is injection-molded in the insert molding, it is easy to maintain the shape of the function surface of the partial lens barrel 21 after the melted lens resin material passes the surface of the partial lens barrel.

The coefficient of linear expansion of the resin material of the lens 11 is preferably 1/5 times or larger and five times or smaller of the coefficient of linear expansion of the resin material of the partial lens barrel 21. This is because, if the difference between the coefficients of linear expansion of the lens 11 and the partial lens barrel 21 is large when a temperature change occurs in the lens module 100, stress due to a thermal expansion difference occurs on the joint surface of the lens 11 and the partial lens barrel 21. As a result, it is likely that the lens surface shape is distorted and the optical performance of the lens module 100 is deteriorated. For this reason, in order to further reduce the stress due to the thermal expansion difference, it is more preferable to set the coefficient of linear expansion of the resin material of the lens 11 to 1/3 times or larger or three times or smaller of the coefficient of linear expansion of the resin material of the partial lens barrel 21 if possible. That is, in order to reduce such a thermal expansion difference, the combination of the materials of the lens 11 and the partial lens barrel 21 is more preferably a combination of materials having close coefficients of linear expansion. Specifically, in view of the suitable coefficient of linear expansion of the first material constituting the lens 11 described above, the coefficient of linear expansion of the first material and the coefficient of linear expansion of the second material are preferably 2 to 8×10⁻⁵/°C.

Considering the above, when cyclic olefin polymer is used as the resin material of the lens 11, polycarbonate is suitable as the resin material of the partial lens barrel 21.

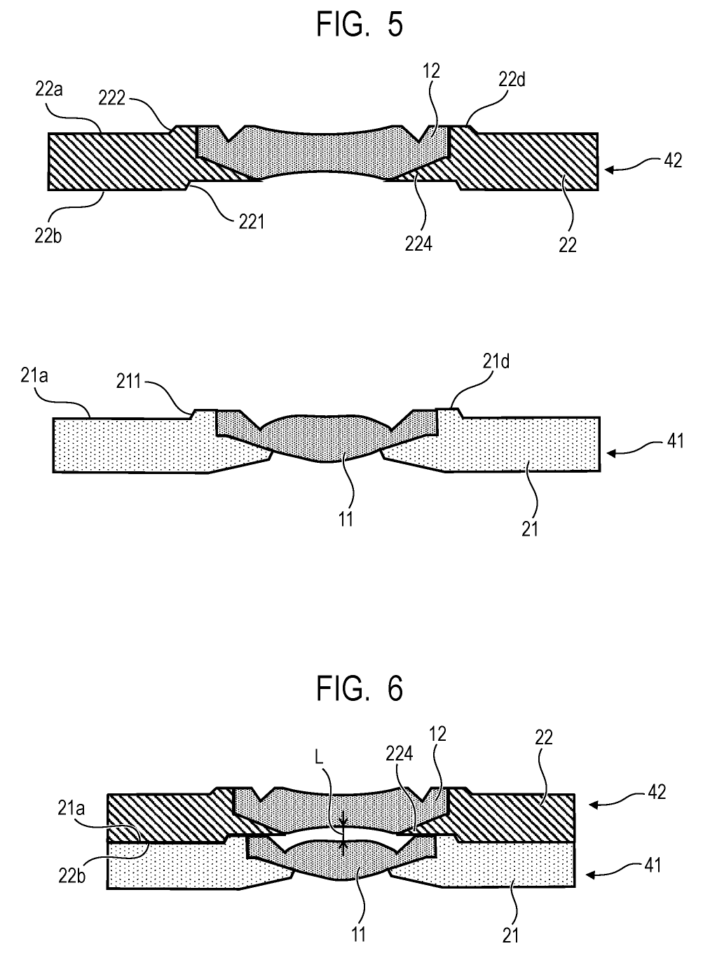

In the partial lens barrel 21 according to the present embodiment, as exemplified in FIG. 4, a partial lens barrel fitting section 211 having a taper shape is formed. More specifically, as illustrated in a cross section of FIG. 5, the partial lens barrel fitting section 211 is provided to protrude from an end face 21a of the partial lens barrel 21 arranged on the unit 42 side to the unit 42 side when the lens module 100 is formed.

A taper center axis of the partial lens barrel fitting section 211 and a center axis of the lens 11 are aligned substantially the same. The partial lens barrel fitting section 211 has a taper shape forming, in an external shape, a truncated cone, the diameter of which decreases toward the unit 42, at the time of assembly of the lens module 100. The taper shape of the partial lens barrel fitting section 211 and a partial lens barrel fitting section 221 having a taper shape provided to correspond to the partial lens barrel fitting section 211 in the partial lens barrel 22 are used for assembly. Accordingly, it is possible to define the positions of the respective lens center axes in the unit 41 and the unit 42. These partial lens barrel fitting sections function as an example of a positioning section for determining arrangement of the units at the time of joining of the units. The partial lens barrel fitting section 211 described here functions as a partial lens barrel positioning section.

In order to more firmly join the lens 11 and the partial lens barrel 21, a rough surface or an undercut shape may be provided in a side surface portion of the lens 11 or an inner diameter portion of the partial lens barrel 21. In the illustrated example, a surface in contact with the surface of the outer circumferential portion of the lens 11 in the partial lens barrel 21 is joined to the surface of the outer circumferential portion. Therefore, a contact surface with the lens 11 in the partial lens barrel 21 functions as a surface for holding the lens 11. With the molding method for the unit described above, the roughness of the holding surface coincides with the roughness of the outer circumferential surface of the lens 11, which is the first lens. Further, the unit can be obtained by, besides the insert molding, a method of separately molding a lens and a partial lens barrel and press-fitting the lens into an inner diameter portion of the partial lens barrel or by integrating the lens and the partial lens barrel with an adhesive or thermal caulking. A plurality of lenses may be integrally joined to the partial lens barrel.

The units 42, 43, and 44 are manufactured using the same process as the process for the unit 41 exemplified above or a publicly-known manufacturing process. At that time, in the unit 42, the partial lens barrel fitting section 221 having the taper shape corresponding to the partial lens barrel fitting section 211 is formed on an end face 22b of the partial lens barrel 22. In the unit 42, a partial lens barrel fitting section 222 having a taper shape similar to the taper shape of the partial lens barrel fitting section 211 and provided to protrude from an end face 22a of the partial lens barrel 22 to the partial lens barrel 23 side is formed (see FIG. 5).

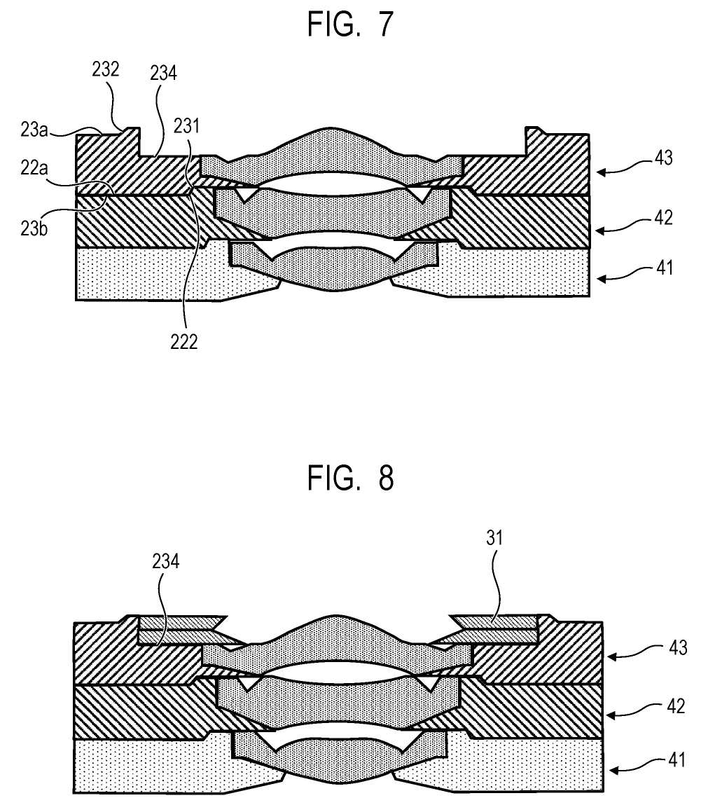

In the unit 43, a partial lens barrel fitting section 231 having a taper shape corresponding to the partial lens barrel fitting section 222 is formed on an end face 23b of the partial lens barrel 23 (see FIG. 7). In the unit 43, a partial lens barrel fitting section 232 having a taper shape similar to the taper shape of the partial lens barrel fitting section 211 and provided to protrude from an end face 23a of the partial lens barrel 23 to the partial lens barrel 24 side is formed (see FIG. 7). Here, in the lens module 100 according to the present embodiment, the light blocking member 31 is arranged between the lens 13 and the lens 14 (see FIG. 8). For this reason, in the partial lens barrel 23, a light blocking member housing section 234 formed by a concave section corresponding to the external shape of the light blocking member 31 is provided in order to house the annular light blocking member 31.

In the unit 44, a partial lens barrel fitting section 241 having a taper shape corresponding to the partial lens barrel fitting section 232 is formed on an end face 24b of the partial lens barrel 24 (see FIG. 9). When the four units 41, 42, 43, and 44 having the structure described above are prepared, the flow shifts to the second manufacturing process in step S302.

In the second manufacturing process in step S302, the four units 41, 42, 43, and 44 are stacked to be arranged in this order in an extending direction of the optical axis P. Details of the stacking process are described below with reference to FIGS. 5 to 9. FIGS. 5 to 9 are diagrams illustrating, stepwise, a process of sequentially stacking the four units and schematically illustrate a structure of a cross section obtained by cutting these components in the optical axis P direction.

First, a stacking process for the unit 41 and the unit 42 is described with reference to FIGS. 5 and 6. The partial lens barrel fitting section 211 and the partial lens barrel fitting section 221 are respectively formed in the two units 41 and 42 manufactured in the first manufacturing process. Center axes of the respective partial lens barrel fitting sections 211 and 221 are aligned with center axes of the lens 11 and the lens 12. The center axes of the lenses 11 and 12 are structured to be aligned in a lens barrel by fitting the partial lens barrel fitting section 211 into the partial lens barrel fitting section 221.

A convex taper of the partial lens barrel fitting section 211 and a concave taper of the partial lens barrel fitting section 221 are configured to have substantially the same taper angle. The inner diameter of the concave taper is set larger than the outer diameter of the convex taper. For this reason, as illustrated in FIG. 6, the end face 21a of the partial lens barrel of the unit 41 and the end face 22b of the partial lens barrel of the unit 42 come into contact while being guided by the tapers of the partial lens barrel fitting sections 211 and 221. At this time, an inter-lens distance L between the lens 11 and the lens 12 is defined by the position of the contact surface.

Note that, in the present embodiment, a mask section 224 is provided in an opening section of the partial lens barrel 22. Since the inner diameter of the mask section 224 decreases from the unit 43 side toward the unit 41 side, the mask section 224 has a function of blocking unnecessary light that passes through a brim section of the lens 11 and preventing stray light.

In the related art, the lens and the light blocking section are assembled to the integrated lens barrel in order from one direction. For that reason, an inner diameter section narrower than the outer diameter of a member to be incorporated cannot be formed in a lens barrel on the one direction side. However, in the present embodiment, since the lens barrel is divided into a plurality of partial lens barrels and the plurality of partial lens barrels are individually stacked to obtain the lens module, an opening section narrower than a maximum diameter member can be formed regardless of arrangement of each of a plurality of lenses and light blocking components. Therefore, as a component substituting the light blocking component of the related art, the mask section 224 exemplified above can be integrated with the partial lens barrel 22 and molded and the number of components can be reduced. Note that the mask section is not limited to be arranged in the partial lens barrel 22 and may be provided in another partial lens barrel.

After the units 41 and 42 are stacked, as illustrated in FIG. 7, the unit 43 is successively stacked on the unit 42. At that time, a convex taper of the partial lens barrel fitting section 222 and a concave taper of the partial lens barrel fitting section 231 are configured to have substantially the same taper angle. The inner diameter of the concave taper is set larger than the outer diameter of the convex taper. For this reason, as illustrated in FIG. 7, the end face 22a of the partial lens barrel of the unit 42 and the end face 23b of the partial lens barrel of the unit 43 come into contact while being guided by the tapers of the partial lens barrel fitting sections 222 and 231.

Further, in the present embodiment, the light blocking member 31 is arranged between the unit 43 and the unit 44. In an assembly process for the units 43 and 44, as illustrated in FIG. 8, the light blocking member 31 is installed in the light blocking member housing section 234 of the unit 43 and the unit 44 is further stacked on the unit 43 to fix the position of the light blocking member 31. At that time, as at the time of stacking the units 41, 42, and 43, guidance of a joining position is performed by the convex partial lens barrel fitting section 232 and the concave partial lens barrel fitting section 241 having substantially the same angle. As illustrated in FIG. 9, the end face 23a of the partial lens barrel of the unit 43 and the end face 24b of the partial lens barrel of the unit 44 come into contact.

The lens module 100 is formed by stacking the units in these processes. Note that, in the assembly of the units, the contact surfaces of the taper sections and the partial lens barrels for aligning the optical axes of the respective lenses are desirably rotatable around the optical axes in order to adjust a lens phase at the time of the assembly. The contact surfaces may have a positioning shape for defining a rotation phase in order to further facilitate assembly work. When the four units 41, 42, 43, and 44 are integrally stacked along the optical axis P by the processes described above, the flow shifts to the third manufacturing process in step S303.

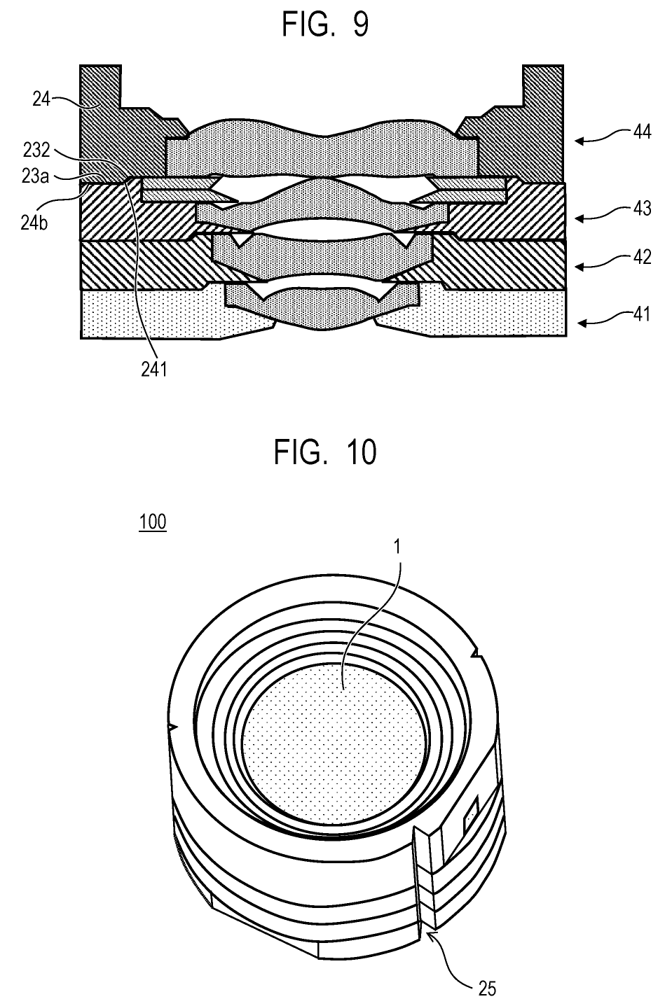

In the third manufacturing process in step S303, the fit and positioned units 41, 42, 43, and 44 are fixed. The units can be integrated by joining the side surface portions of the respective partial lens barrels. An example of an integration method is described with reference to FIG. 10. FIG. 10 is a perspective view of the lens module 100 schematically illustrating the example of the integration method.

A cutout 25 forming a continuous groove when the units are stacked is provided in the partial lens barrel surface sections of the lens module 100 illustrated in FIG. 10. The units are joined and integrated by applying an adhesive (not illustrated) to the cutout 25 and hardening the adhesive. Note that, as the adhesive to be used, thermoplastic resin, energy hardening resin, an instant adhesive, and the like can be selected. However, an adhesive, an outgas of which does not cause a shadow and does not cause deterioration in lens optical performance, is more suitable. The joining of the partial lens units may be joining by another method such as heating and welding the partial lens barrel side surface sections. Here, the lens module 100 is obtained by using the units described above in all the four lenses. However, only the units 42 and 43 may be configured as described above and the lenses 11 and 14 may be used without forming the units. Alternatively, the units 41, 42, and 43 may be used and the lens 14 may be used without forming the unit.

Concerning a lens module used in a small camera or the like, by adopting the configuration described above, it is possible to achieve facilitation of assembly and a reduction in assembly cost for a small lens composed of the structure of the related art. Further, it is possible to reduce the number of components. From this point as well, it is possible to reduce assembly cost.

### Second Embodiment

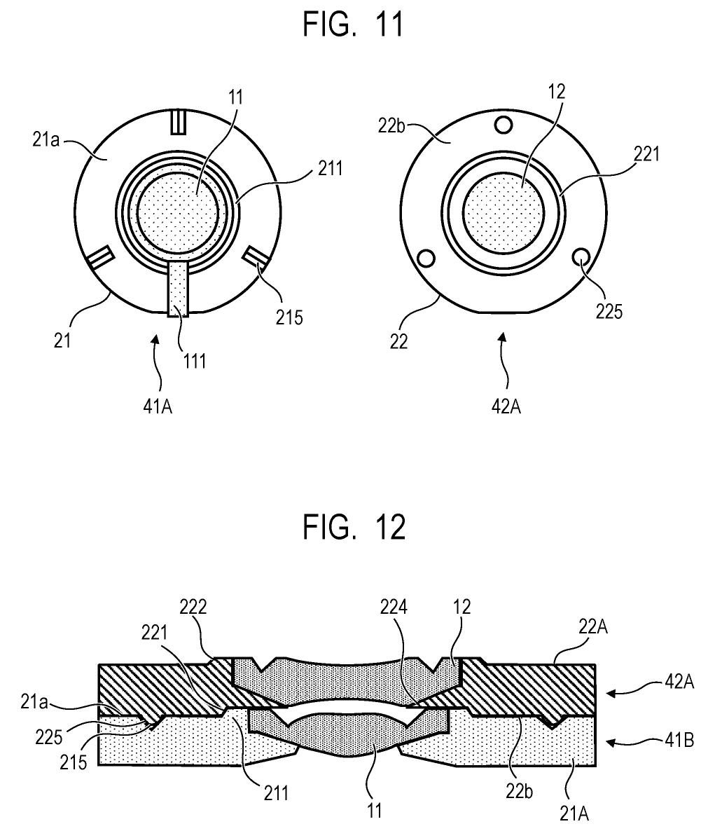

In the first embodiment, when the respective units are stacked, the positioning of the optical axes of the respective lenses is achieved by using, as the positioning sections, the partial lens barrel fitting sections having the taper shapes provided in the units. In contrast, in a second embodiment, positioning is more suitably performed by arranging further positioning structures for units. The shapes of units 41A and 42A according to the present embodiment and processes corresponding to the processes exemplified in FIGS. 5 and 6 in step S302 are described below with reference to FIGS. 11 and 12. Note that, in the following explanation, portions having functions and structures similar to those of the units 41 and 42 described in the first embodiment are denoted by the same reference numerals and signs and explanation of the portions is omitted below. FIG. 11 illustrates a top view of the end face 21a of the unit 41A and a top view of the end face 22b of the unit 42A. FIG. 12 illustrates a state in which the units 41A and 42A are stacked each other in the same mode as FIG. 6 in the first embodiment

In the first embodiment, the optical axes of the units 41 and 42 are aligned by aligning the partial lens barrel fitting sections 211 and 221. The inter-lens distance L between the lenses 11 and 12 is defined by the end face 21a of the partial lens barrel 21 and the end face 22b of the partial lens barrel 22. More specifically, the positions in the optical axis direction are defined based on these end faces by the lens surface of the lens 11 and the lens surface of the lens 12 to be set. In contrast, in the second embodiment, in order to define the distance between the lens 11 and the lens 12, positioning groove sections 215 and positioning protrusions 225 are respectively provided for the units 41A and 42A.

The positioning groove sections 215 and the positioning protrusions 225 are respectively provided at three or more points in the same phase in a partial lens barrel 21A and a partial lens barrel 22A. In the present embodiment, a case in which the positioning groove sections 215 and the positioning protrusions 225 at three points are provided is exemplified. The positioning protrusions 225 are provided to protrude from the end face 22b toward the unit 41A at the time of stacking. The positioning groove sections 215 are formed as grooves having a triangular shape in cross section extending from the inner side to the outer side of the end face 21a and are shaped such that, when the positioning protrusions 225 are installed, the protrusions come into contact with inclined sections of the grooves.

By arranging the groove sections and the protrusions, the distance between the lens 11 and the lens 12 can be managed by the dimensions of the positioning groove sections 215 and the positioning protrusions 225. Accordingly, it is possible to more precisely adjust the inter-lens distance L. Further, since the position with respect to the optical axis rotation direction is fixed by fitting the positioning protrusions 225 in the positioning groove sections 215, it is easy to adjust the rotation position in the optical axis direction in step S302. Note that the shapes of the positioning groove sections 215 and the positioning protrusions 225 described in the present embodiment are an example of a positioning section. These shapes are not limited to the exemplified ones if the same operational advantage can be obtained.

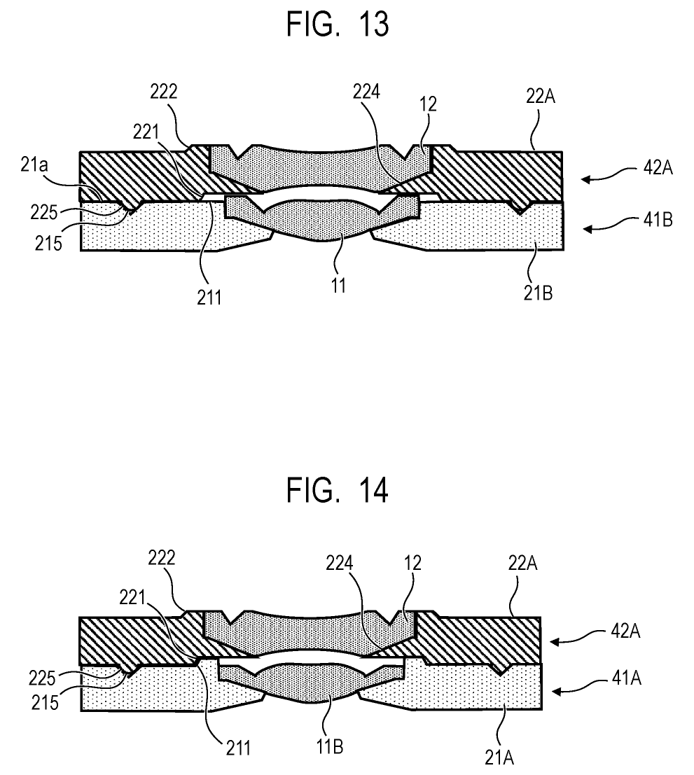

In the case of the present embodiment, the positioning in the optical axis direction of the units can also be performed by only the positioning groove sections 215 and the protrusions 225. FIG. 13 illustrates such an aspect in the second embodiment in the same mode as FIG. 12. In a partial lens barrel 21B in an illustrated unit 41B, the partial lens barrel fitting section 211 in FIG. 12 is absent and the end face 21a extends to a region where the partial lens barrel fitting section 211 is present in FIG. 12. Accordingly, a part of the lens 11 is arranged in a space provided between the partial lens barrel 21B and the partial lens barrel 22A. By provided such components for a lens module, it is possible to select lenses having more shapes as lenses used in the lens module.

FIG. 14 illustrates a further aspect in the second embodiment in the same mode as FIG. 12. In a lens 11B in the illustrated unit 41A, the thickness decreases near the outer circumference of the lens 11 in FIG. 12 and the partial lens barrel fitting section 211 is located further on the partial lens barrel 22A side than the outer circumference portion of the lens 11B. Accordingly, a part of the partial lens barrel 21A is arranged in a space provided between the lens 11B and the lens 12. By providing such components for the lens module, it is possible to select lenses having more shapes as lenses used in the lens module.

### Third Embodiment

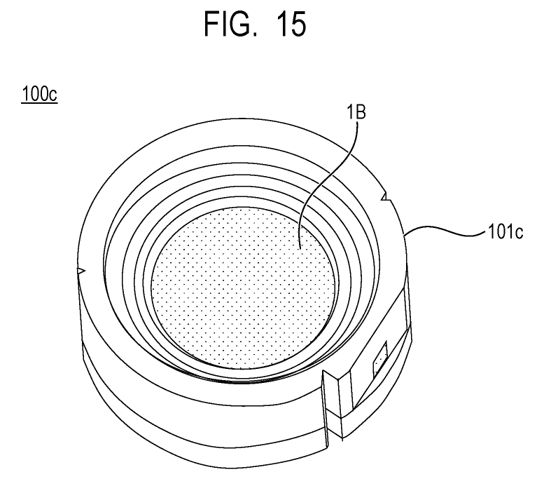

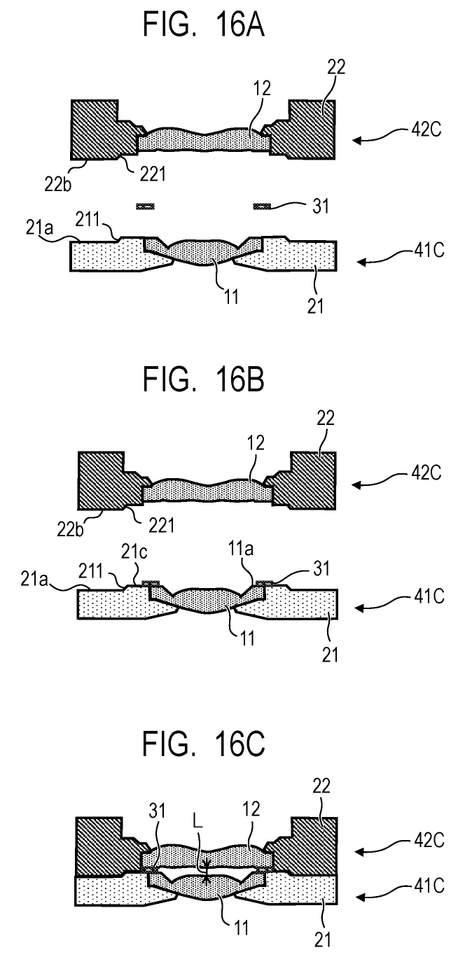

In the first embodiment, the lens module 100 including the four lenses is described. In the present disclosure, the number of lenses arranged in the lens module is not limited to four. In a third embodiment, a shape of and a manufacturing method for a lens module 100C in the case in which the number of lenses is two are described. As the third embodiment, the lens module 100C in the present embodiment is described below with reference to FIG. 15 and FIGS. 16A to 16C. FIG. 15 is a perspective view of the lens module 100C in the present embodiment. FIGS. 16A to 16C are diagrams for describing, stepwise, the processes described in step S302 in the flowchart of FIG. 2 while illustrating cross sections of units as in FIG. 5 and the like. In the present embodiment, a lens barrel 101C is formed by stacking two units 41C and 42C and a lens section 1C includes the lens 11 and the lens 12.

A manufacturing method for the lens module 100C according to the present embodiment is described below with reference to FIGS. 16A to 16C. Note that, in the following explanation, portions having functions and structures similar to those of the units 41 and 42 described in the first embodiment are denoted by the same reference numerals and signs and explanation of the portions is omitted below. First, as illustrated in FIG. 16A, the units 41C and 42C are created by the same method as the method described in step S301 in the first embodiment. The annular light blocking member 31 is prepared.

In the subsequent process corresponding to step S302, first, as illustrated in FIG. 16B, the light blocking member 31 is placed on the unit 41C. At that time, in the present embodiment, the light blocking member 31 is placed on at least one of an end face 21c, which is the upper surface, of the partial lens barrel fitting section 211 of the unit 41C and an outer circumferential surface 11a of the surface on the lens 12 side of the lens 11. Subsequently, as illustrated in FIG. 16C, the unit 42C is stacked on the unit 41C and the light blocking member 31.

At this time, as in the first embodiment, the partial lens barrel fitting sections 211 and 221 respectively aligned with the optical axes of the lenses 11 and 12 are provided in the units 41C and 42C. By fitting the partial lens barrel fitting sections 211 and 221 with each other, it is possible to assemble the units 41C and 42C while aligning the optical axes of the units 41C and 42C. Note that, as in the first embodiment, in a process of assembling three components of the units 41C and 42C and the light blocking member 31, the inter-lens distance L between the lenses 11 and 12 can be decided by the end face 21a and the end face 22b. However, in the present embodiment, since the light blocking member 31 is sandwiched while being brought into contact with the units 41C and 42C, the inter-lens distance L can also set by the thickness of the light blocking member 31.

Note that, the present embodiment indicates that the present disclosure can be applied to not only the lens module including the four lenses but also a lens module including a plurality of lenses such as a lens module including two lenses. However, the present disclosure can also be applied to lens modules other than the exemplified lens modules. For example, concerning a lens module including a lens group for which assembly is relatively easy, a configuration in which the lens group is inserted into a single lens barrel is used. Concerning a lens group for which assembly is difficult, the lens module according to the present disclosure is used. These lens modules may be combined to obtain a final lens module. That is, the present disclosure can be applied to a lens module including the at least two units described above. The lens module according to the present disclosure and the lenses of the related art may be used in combination. Specifically, a single or a plurality of units according to the present disclosure and a single or a plurality of lenses can be combined to obtain a lens module. When the lens module is obtained by stacking the plurality of lenses in the optical axis direction as described above, it is preferable to arrange the lenses of the related art for which positioning is relatively easily in the front or the rear or both of the front and the rear in the optical axis direction and arrange the units described above in an optical axis direction intermediate portion for which positioning is relatively difficult.

### Fourth Embodiment

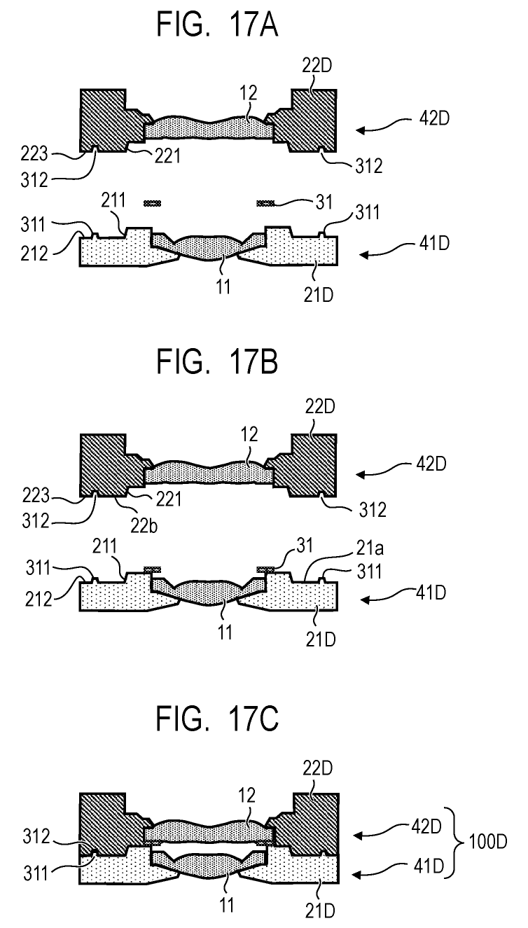

A fourth embodiment is a modification of the process illustrated in step S303 in the first embodiment in the flowchart of FIG. 3. In the present embodiment, when a plurality of units are stacked in step S302 without being welded or bonded, the units are integrated using a press-fitting shape arranged between units adjacent to each other. A manufacturing method for a lens module 100D in the present embodiment is described with reference to FIGS. 17A to 17C. Note that, here, a case in which the two lenses are provided described in the third embodiment is described. In the following explanation, portions having functions and structures similar to those of the units 41 and 42 described in the first embodiment are denoted by the same reference numerals and signs and explanation of the portions is omitted below.

In the present embodiment, in units 41D and 42D, press-fitting protrusions 311 and press-fitting groove sections 312 to be engaged at the time of assembly are respectively provided. The press-fitting protrusions 311 are formed to protrude from the end face 21a facing a partial lens barrel 22D of the unit 42D in a partial lens barrel 21D of the unit 41D. The press-fitting groove sections 312 are formed as grooves or holes having a size in which the press-fitting protrusions 311 can fit on the end face 22b facing the partial lens barrel 21D in the partial lens barrel 22D. In the respective units, the press-fitting protrusions 311 and the press-fitting groove sections 312 are arranged in parts corresponding to each other. The press-fitting groove sections 312 are manufactured in dimensions in which the press-fitting protrusions 311 can be press-fit.

In an actual manufacturing process, two units and the light blocking member 31 illustrated in FIG. 17A are arranged and the light blocking member 31 is placed on the unit 41D as illustrated in FIG. 17B. Subsequently, as illustrated in FIG. 17C, the units 41D and 42D are stacked each other and fixed.

Next, details of a fixing process are described. First, optical axes of the units 41D and 42D are aligned. Specifically, the partial lens barrel fitting sections 211 and 221 come into contact first. While the optical axes being aligned by the partial lens barrel fitting sections 211 and 221, the end face 21a of the unit 41D and the end face 22b of the unit 42D are fit to be brought close. Thereafter, the press-fitting protrusions 311 are inserted into opening sections of the press-fitting groove sections 312. The press-fitting protrusions 311 and the press-fitting groove sections 312 have shapes and dimensions fixed by pushing-in, driving-in, or press-fitting to each other, that is, tightening margins with which components cannot relatively move at the time of engagement.

A taper shape is given to the press-fitting protrusions 311. The press-fitting protrusions 311 are easily introduced into the press-fitting groove sections 312 by the taper shape at the time of press-fitting. After the press-fitting, by breaking the tightening margins provided in the press-fitting protrusions 311, the units 41D and 42D are fixed and the lens module 100D is manufactured. Note that, here, the press-fitting protrusions 311 are provided in the unit 41D and the press-fitting groove sections 312 are provided in the unit 42D. However, the press-fitting protrusions 311 and the press-fitting groove sections 312 may be oppositely provided. When the press-fitting protrusions 311 and the press-fitting groove sections 312 are provided in plurality, some of the press-fitting protrusions 311 and some of the press-fitting groove sections 312 may be provided dividedly in the second units 41D and 42D.

### Other embodiments

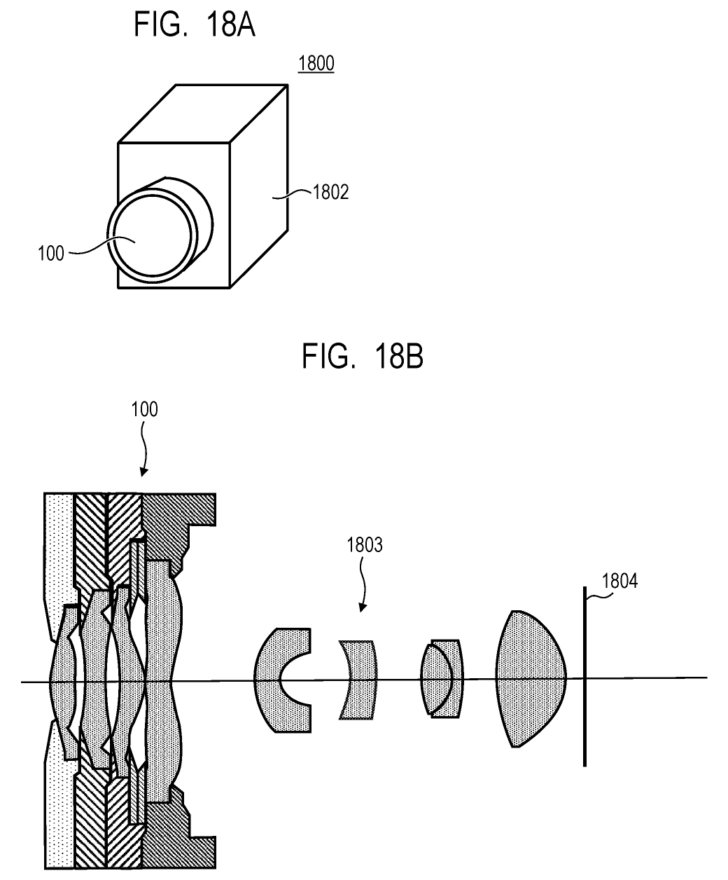

As described above, the lens module according to the present disclosure can achieve facilitation of assembly and a reduction in assembly cost in manufacturing of the lens module. The present disclosure can also be applied to an optical apparatus including an imaging apparatus exemplified by a camera using the lens module and an information terminal exemplified by a smartphone. FIGS. 18A and 18B illustrate an imaging apparatus, which is an example of an optical apparatus using the lens module. FIG. 18A is a perspective view of an imaging apparatus 1800 and FIG. 18B is a diagram schematically illustrating optical components in the imaging apparatus 1800.

The imaging apparatus 1800 includes a housing 1802, the lens module 100 exemplified in FIG. 1 and the like, an imaging element 1804, and an optical system 1803 that forms an image of light having passed through the lens module 100 on the imaging element 1804. The imaging element 1804 receives light from a not-illustrated subject having passed through the lens module 100. By applying the present disclosure to the imaging apparatus 1800, it is possible to reduce cost of optical elements such as lenses. In the lens module 100, since a limitation of an effective optical diameter of a lens is lowered compared with the lens module of the related art, it is expected that a degree of freedom in design also increases.

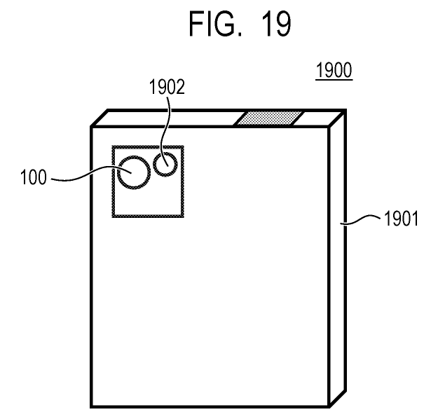

FIG. 19 is a perspective view of a smartphone 1900, which is an example of an information terminal that is electronic equipment using the lens module 100 exemplified in FIG. 1 and the like. The smartphone 1900 uses the lens module 100 in an imaging function section provided in a main body 1901. A light emitting element 1902 used as a flash that illuminates an imaging target object is provided beside the lens module 100. The lens module 100 according to the present disclosure is easily reduced in size and is expected to increase a degree of freedom in design of the smartphone. A very small lens module is required for such electronic equipment. The lens module 100 according to the present disclosure can also be applied to an endoscope in which a light emitting element needs to be arranged at a distal end portion together with the lens module. When the lens module according to the present disclosure is used at the endoscope distal end portion, it is possible to increase a degree of freedom of arrangement for providing the light emitting element. It is also possible to increase a degree of freedom of design of the endoscope itself.

As described above, the lens module (100) according to the present disclosure includes, for example, the at least two units of the unit (41) and the unit (42). The unit (41) includes the lens (11) and includes, integrally with the lens 11, the partial lens barrel (21) that holds the lens (11). The unit (42) includes the lens (12) and includes, integrally with the lens (12), the partial lens barrel (22) that holds the lens (12). The unit (42) is joined to the unit (41) such that the optical axis of the lens (11) and the optical axis of the lens (12) coincide. Note that, in the present disclosure, the partial lens barrels described above can also be referred to as holders because the partial lens barrels hold the lenses. By joining the individual units to cause the optical axes of the respective lenses to coincide and obtaining the lens module (100) as described above, it is possible to achieve facilitation of assembly and a reduction in assembly cost in the lens module (100).

Note that the number of units to be joined can be changed according to optical performance required of the lens module. The partial lens barrel (21) and the partial lens barrel (22) can be provided by a light blocking material from the viewpoint of suppressing stray light of light transmitted through the lenses. At that time, the partial lens barrels made of the light blocking material can be changed according to optical performance required of the lens module to, for example, form the partial lens barrel (21) and the partial lens barrel (23) from the light blocking material rather than arranging the partial lens barrels side by side as described above.

As exemplified in FIG. 13, in the extending direction of the optical axis P, a part of the lens 11 or a part of the lens (12) may be arranged to be located in a region between the partial lens barrel 21B and the partial lens barrel 22A. In the illustrated example, a part of the lens 11 is located in the region. However, a part of the lens 12 can also be located in the region by, for example, changing the shape of the partial lens barrel 22A. As exemplified in FIG. 14, in the extending direction of the optical axis P, a part of the partial lens barrel 21 or a part of the partial lens barrel 22A may be arranged to be located in a region between the lens 11B and the lens 12. In the illustrated example, a part of the partial lens barrel 21A (the partial lens barrel fitting section 211) is located in the region. However, a part of the partial lens barrel 22A can also be located in the region by, for example, changing the shape of the lens 12.

In the lens module (100) described above, the partial lens barrel (21) and the partial lens barrel (22) can be in contact with each other by the contactable surfaces (21a and 22b). By joining the unit (41) and the unit (42) in a state in which these surfaces are in contact, it is possible to set the inter-lens distance L between the lens (11) and the lens (12) to a desired value.

Note that, in the structure of the unit, as exemplified in FIG. 5, for example, a part of the partial lens barrel 21 is provided to join with a part of the outer circumference of the lens 11. As exemplified in FIG. 4, the unit can be obtained by insert-molding the lens into the partial lens barrel. In this case, the surface roughness of the surface on which the partial lens barrel 21 holds the lens 11 in the partial lens barrel 21 coincides with the surface roughness of the surface held by the partial lens barrel 21 of the lens 11 in the lens 11.

In the lens module (100) described above, a positioning section can be provided in the partial lens barrel. For example, as exemplified in FIG. 5, the partial lens barrel 21 can include the partial lens barrel fitting section 211 as the partial lens barrel positioning section and the partial lens barrel 22 can include the partial lens barrel fitting section 221 as the partial lens barrel positioning section. The partial lens barrel fitting section 211 and the partial lens barrel fitting section 221 can cooperate to cause the optical axis of the lens 11 and the optical axis of the lens 12 to coincide when the unit 41 and the unit 42 are joined. In this case, the partial lens barrel positioning section and the partial lens barrel positioning section can have, for example, a concave shape and a convex shape corresponding to each other and fit with each other to cause the respective optical axes of the lenses to coincide.

As exemplified in FIG. 10, in the lens module 100 described above, the partial lens barrel 21 and the partial lens barrel 22 can include cutouts at corresponding positions of the outer circumferential surface. These cutouts constitute a groove section to be the continuous cutout 25 when the unit 41 and the unit 42 are joined. The unit 41 and the unit 42 can be joined by a joining agent such as an adhesive supplied to the cutout 25.

Note that a joining method for units is not limited to the joining method using the cutouts described above. For example, the lens module 100D can also be obtained by the joining method by press-fitting exemplified in FIGS. 17A to 17C. In this case, the partial lens barrel 21D can include at least one of the press-fitting protrusions 311 and the press-fitting groove sections 312 used to join the unit 41D and the unit 42D. The partial lens barrel 22D can include the other of the press-fitting protrusions 311 and the press-fitting groove sections 312 to correspond to at least one of the press-fitting protrusions 311 and the press-fitting groove sections 312 provided in the partial lens barrel 21D.

The present disclosure can also constitute the imaging apparatus exemplified in FIGS. 18A and 18B. In this case, the imaging apparatus 1800 includes the optical system (100, 1803) including the lens module 100 described above and the housing 1802 that houses the optical system. The present disclosure can further constitute an imaging apparatus including the imaging element 1804 that receives light having passed through the optical system. Such an imaging apparatus 1800 can capture an image with the imaging element 1804. When the present disclosure constitutes the smartphone 1900 exemplified as electronic equipment, the smartphone 1900 can be used as the imaging apparatus exemplified in FIGS. 18A and 18B and can be electronic equipment including a display element that is usually provided in the smartphone and displays a captured image.

Further, the present disclosure can constitute the manufacturing method for the lens module 100 as exemplified in FIG. 3. In this case, the manufacturing method includes the three processes (steps S301 to S303). Step S301 corresponds to the process of at least manufacturing the unit 41 and the unit 42 described above. In this case, step S302 corresponds to the process of positioning the unit 41 and the unit 42 to cause the optical axis of the lens 11 and the optical axis of the lens 12 to coincide. Step S303 corresponds to the process of joining the positioned units 41 and 42.

According to an aspect of the present disclosure, it is possible to provide a lens module having satisfactory optical characteristics and an optical apparatus, an imaging apparatus, and electronic equipment using the lens module.

Note that the present disclosure is not limited to the embodiments described above and a number of modifications are possible within the technical idea of the present disclosure. The advantageous effects described in the embodiments only list most suitable effects produced from the present disclosure. Advantageous effects by the present disclosure are not limited to the advantageous effects described in the embodiments.

The embodiments described above can be modified as appropriate without departing from the technical idea. For example, a plurality of embodiments can be combined. A part of matters of at least one embodiment can be deleted or replaced. A new matter can be added to at least one embodiment. Note that the disclosed content of the present specification includes not only those explicitly described in the present specification but also all matters that can be grasped from the present specification and the drawings attached to the present specification.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-011274, filed January 27, 2025, and Japanese Patent Application No. 2025-185791, filed November 4, 2025, which are hereby incorporated by reference herein in their entirety.

What is claimed is:

1. A lens module comprising:
a first unit including a first lens made of a first material and a first holder made of a second material different from the first material and configured to hold the first lens; and
a second unit including a second lens and a second holder made of a material different from a material of the second lens and configured to hold the second lens, wherein
the first material is a resin material which is an acrylic resin or a cyclic olefin polymer, or a glass material, and
the first lens and the second lens overlap in an optical axis direction of the lens module, and the first holder and the second holder fit with each other.

2. The lens module according to claim 1, wherein
the second material is crystalline resin, and
a glass transition temperature of the first material is lower than a melting point of the second material.

3. The lens module according to claim 1, wherein the second material is a polycarbonate or acrylic resin.

4. The lens module according to claim 1, wherein the first material and the second material form an interface and are in contact.

5. The lens module according to claim 1, wherein the first material and the second material are compatible.

6. The lens module according to claim 1, wherein the first unit is a molded body wherein the first lens is insert-molded into the first holder.

7. The lens module according to claim 1, wherein the second lens is made of a same material as the material of the first lens, and the second holder is made of a same material as the material of the first holder.

8. The lens module according to claim 1, wherein the first holder and the second holder are made of a light blocking material.

9. The lens module according to claim 1, wherein, in the optical axis direction, at least one of a part of the first lens and a part of the second lens is located between the first holder and the second holder.

10. The lens module according to claim 1, wherein, in the optical axis direction, at least one of a part of the first holder and a part of the second holder is located between the first lens and the second lens.

11. The lens module according to claim 1, wherein the second lens is in contact with a space that is in contact with the first lens, and a light blocking member is provided between the first lens and the second lens.

12. The lens module according to claim 11, wherein a part of the light blocking member is located between the first holder and the second holder.

13. The lens module according to claim 1, further comprising a third lens and a fourth lens, wherein
the third lens and the fourth lens overlap the first lens and the second lens in the optical axis direction of the lens module.

14. The lens module according to claim 13, wherein the first lens and the second lens are located between the third lens and the fourth lens.

15. The lens module according to claim 1, further comprising a third unit including a third lens and a third holder made of a material different from a material of the third lens and configured to hold the third lens, wherein
the second lens and the third lens overlap in the optical axis direction of the lens module, and the second holder and the third holder fit with each other.

16. The lens module according to claim 15, further comprising a fourth unit including a fourth lens and a fourth holder made of a material different from a material of the fourth lens and configured to hold the fourth lens, wherein
the third lens and the fourth lens overlap in the optical axis direction of the lens module, and the third holder and the fourth holder fit with each other.

17. The lens module according to claim 1, wherein the first holder and the second holder are in contact with each other.

18. The lens module according to claim 1, wherein the first holder is provided in contact with an outer circumference of the first lens.

19. The lens module according to claim 1, wherein the first holder includes a first groove section, the second holder includes a second groove section, the first groove section and the second groove section are continuous, and a joining agent is arranged in the first groove section and the second groove section.

20. The lens module according to claim 1, wherein
the first holder includes at least one of a press-fitting protrusion and a press-fitting groove section that join the first unit and the second unit, and
the second holder includes the other of the press-fitting protrusion and the press-fitting groove section to correspond to the at least one of the press-fitting protrusion and the press-fitting groove section.

21. An optical apparatus comprising:
an optical system including the lens module according to claim 1; and
a housing that houses the optical system.

22. An imaging apparatus comprising:
an optical system including the lens module according to claim 1; and
an imaging element that receives light having passed through the optical system.

23. A lens module comprising:
a first unit including a first lens made of a first material and a first holder made of a second material different from the first material and configured to hold the first lens; and
a second unit including a second lens and a second holder made of a material different from a material of the second lens and configured to hold the second lens, wherein
a coefficient of linear expansion of the first material is 1/5 times or larger and five times or smaller of a coefficient of linear expansion of the second material, and
the first lens and the second lens overlap in an optical axis direction of the lens module, and the first holder and the second holder fit with each other.

24. The lens module according to claim 23, wherein a coefficient of linear expansion of the first material and a coefficient of linear expansion of the second material are 2 to 8×10⁻⁵/°C.

25. The lens module according to claim 23, wherein the first material is a polycarbonate, a acrylic resin, or a cyclic olefin polymer.

26. A lens module comprising:
a first unit including a first lens made of a first material and a first holder made of a second material different from the first material and configured to hold the first lens; and
a second unit including a second lens and a second holder made of a material different from a material of the second lens and configured to hold the second lens, wherein
the second material is an amorphous resin, and
the first lens and the second lens overlap in an optical axis direction of the lens module, and the first holder and the second holder fit with each other.

27. The lens module according to claim 26, wherein a glass transition temperature of the first material is lower than a glass transition temperature of the second material.

28. Electronic equipment comprising:
an optical system including the lens module according to claim 2;
an imaging element that receives light having passed through the optical system; and
a display element that displays an image captured by the imaging element.

29. Electronic equipment comprising:
an optical system including the lens module according to claim 3;
an imaging element that receives light having passed through the optical system; and
a light emitting element that illuminates an imaging target object.

30. A manufacturing method for a unit including a lens and a holder that holds the lens, the manufacturing method comprising installing the holder in a die and feeding a cyclic olefin polymer or an acrylic resin into the die to insert-mold the lens into the holder.
